(19) United States
(12) Patent Application Publication
(10) Pub. No.: US 2009/0287684 A1
(43) Pub. Date: Nov. 19, 2009

(54) HISTORICAL INTERNET

(76) Inventor: James D. Bennett, Hroznetin (CZ)

Correspondence Address: GARLICK HARRISON & MARKISON, P.O. BOX 160727, AUSTIN, TX, 78716-0727, US

(21) Appl. No.: 12/422,453

(22) Filed: Apr. 13, 2009

Related U.S. Application Data
(60) Provisional application No. 61/053,138, filed on May 14, 2008.

(51) Int. Cl. G06F 17/30

(52) U.S. Cl. 707/5; 707/E17.108; 707/E17.044

(57) ABSTRACT

An Internet infrastructure that supports a timed window search service comprising a search server. The search server receives a search string from a client device and has access to a historical data repository from where different content can be provided for the search based on date/time inputs. The search server includes various modules for web crawling and reverse indexing various search keywords. The search server receives the search string along with certain user-defined criteria such as search in a geographical region or search within browser favorite lists. The search server performs the search operation and delivers the result to the client device. The search server can also retrieve the timed window data and deliver correlating content to client device. The historical data repository comprises indexing module, version manager, and time-based retrieving module facilitates for searching historical timed window data.

### CROSS REFERENCES TO RELATED APPLICATIONS

The present application claims priority under 35 U.S.C. 119(e) to U.S. Provisional Application Ser. No. 61/053,138, filed May 14, 2008, and having a common title with the present application, which is incorporated herein by reference in its entirety for all purposes.

### BACKGROUND

1. Technical Field

The present invention relates generally to search engines; and, more particularly, to Internet search engines that use web browsers.

2. Related Art

The Internet is used extensively in almost all walks of life in today's world. There are millions of web pages containing information on amazing variety of topics. Internet search engines allow a way for many users to search a variety of different information. There are many search engines available today that allow a user to obtain useful information from the Internet. An Internet search using a search engine provides the user with links to various web pages containing data that may be of interest to the user. Though a search engine may provide search results providing links to web pages, the links may not exist at the present time. The information can be obtained from browsing the Internet from one or more known Uniform Resource Locators (URLs). The URLs can generally be obtained from a magazine, the favorites list from a web browser, search engines, another web page, hypertext links from outside the web environment such as a Portable Data Format (PDF) file, and other sources. The Internet is an ever-changing environment, with content, links, structure, data, etc changing at a rapid pace. Therefore, the Internet is a fast moving target for software, applications, computers, user, etc., to keep up with. When the web page is created, it gives right information at that time. One can not access the web pages that exist today if the server is down, the company web page do not exists since it is out of business, the web page name has completely changed or been remapped to a new location or URL, or the required data is no longer available. Access to the required web page may not be available from a user's web browser link in the “my favorites” since that favorite was stored a long time back and the location or content that was once associated with the link has been moved, changed, deleted, or updated.

At present, if content is erased, changed, updated, etc., it is not possible to obtain the original web page at a later date or time in the same format with the same content as it existed before the changes. For example, it is not possible to know how a news website existed on a certain day. So, if you wanted to obtain the news that was available on the Internet for Jul. 15, 1999, the information may no longer be available or may have substantially changed. Most news websites, such as www.cnn.com, keeps on changing dynamically, often many times a day, and it is difficult to view the web page as it existed a few days back in time. Sometimes, it is valuable for a user to retrieve this historical or archived data. Some services or applications, like Yahoo™, address this problem to a small extent by storing the recent information in cache. However, when the search engines crawls to obtain current data, this cached data is often lost or overwritten, and the information can be lost if a computer is powered off, resets, or enters a new mode of operation. Also if the website is not crawled for sometime, even this information is lost from the cache as time passes and data is changed inside various computers. Therefore, a need exists on the Internet for preserving and providing access to historical content that existed on the Internet in some past state.

These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a schematic block/step diagram illustrating an Internet infrastructure containing a search server and a historical data repository that searches for the historical data when requested by one or more client devices;

FIG. 2 is a schematic block/step diagram illustrating the process of storing data in the historical data repository during web crawling that is performed by the search server;

FIG. 3 is a schematic circuit diagram illustrating various components of the search server and the historical data repository and their interaction with a client device from FIG. 1;

FIG. 4 is an exemplary schematic diagram illustrating a screen shot of a search server web page showing various options for searching web pages;

FIG. 5 is a schematic block/step diagram illustrating a screen shot of a search web page during a search invoked by a client device of FIG. 1;

FIG. 6 is a schematic flow diagram illustrating the storage of data in the historical data repository during a web crawling process;

FIG. 7 is a schematic flow diagram illustrating the general search process used by the search server of the Internet infrastructure of FIG. 1;

FIG. 8 is a schematic flow diagram illustrating the search process of obtaining historical data via the search server of the Internet infrastructure of FIG. 1; and

FIG. 9 is a flow diagram illustrating a payment procedure that is used to obtain historical data.

### DETAILED DESCRIPTION OF THE DRAWINGS

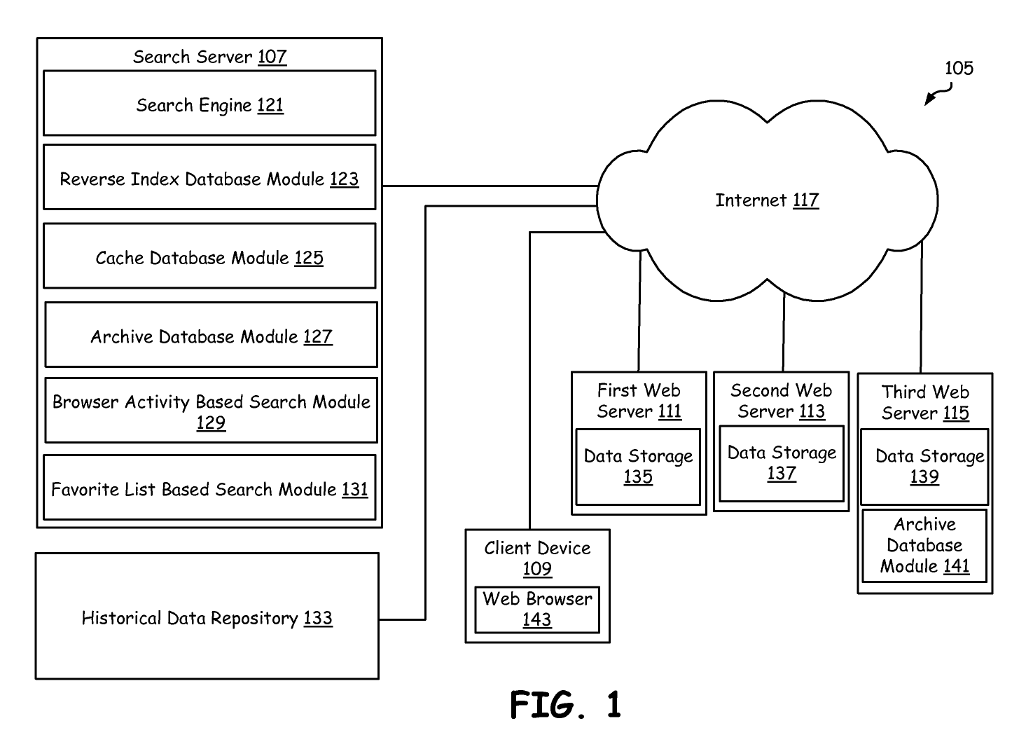

FIG. 1 is a schematic block/step diagram 105 illustrating an Internet infrastructure containing a search server 107 and a historical data repository 133. The historical data repository searches for various historical Internet data when historical-based searches are requested by a client device such as device 109 in FIG. 1. When a user requests that the Internet or a server perform a search, such as a keyword search with definite time window through a client device's interface such as a web browser 143, the search server searches for various correlating search results and produces the search results to the user via the client device web browser 143.

The search server 107 searches the contents in the web servers, such as servers 111, 113 and 115 of FIG. 1. The servers are geographically located anywhere and the search server 107 is connected to the other servers through the Internet 117. The search server 107 contains server application(s) such as a search engine 121, a reverse index database module 123, a cache database 125, an archive database module 127, a browser activity-based search module 129, and a favorite list-based search module 131. The search server 107 is connected or coupled to the web servers 111, 113 and 115 along with a historical data repository 133 through the Internet 117. The exemplary three web servers 111, 113 and 115 store various web page data in the respective data storage areas 135, 137 and 139 shown in FIG. 1. The archive database module 127 may also be located in one or more other web servers, such as archive database module 141 shown in FIG. 1, which stores the archive data of the web server(s) such as server 115 of FIG. 1. Further, FIG. 1 illustrates a specific number of search servers, web servers, and historical data repository. However, any number of search servers, web servers, and historical data repositories may be connected to the Internet and used per the processes and systems taught herein. In addition, while the repository 133 is shown in FIG. 1 and taught herein as a separate device coupled to the Internet, the repository 133 could be a storage device or computer directly connected to or embedded within a server 107, 111, 113, and/or 115, part of one or more client storage systems, or storage distributed across many of these devices.

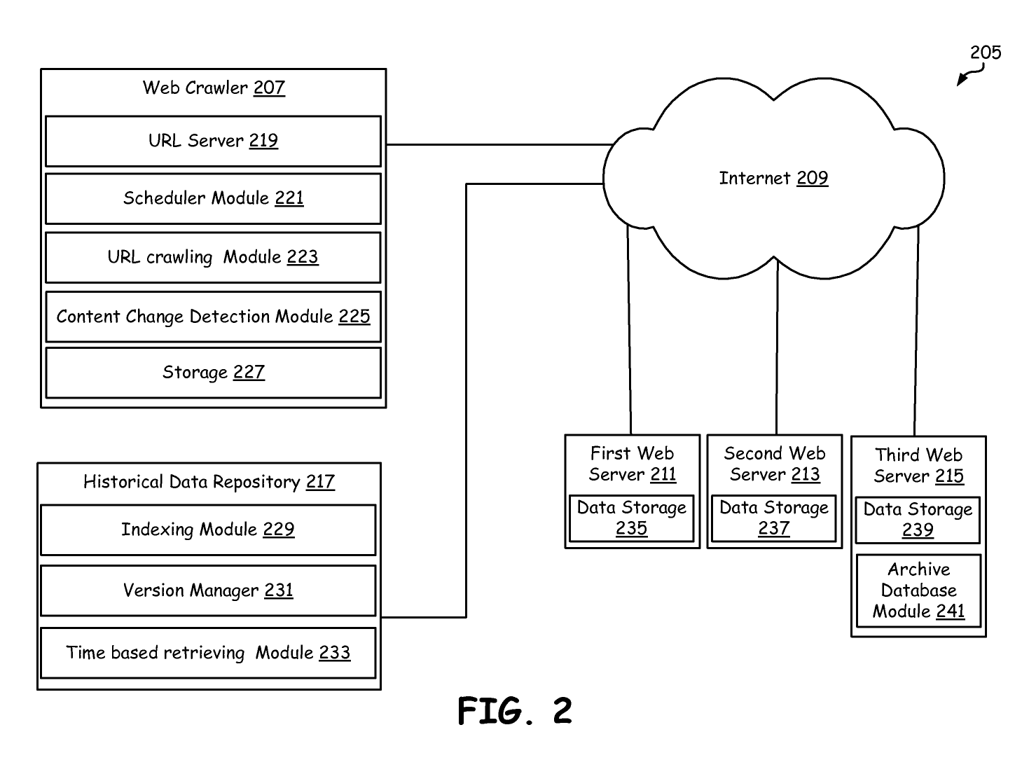

The search engine 121 of the search server 107 basically performs the Internet search functions with the assistance with other components in FIG. 1. The search engine 121 of FIG. 1 uses or contains a web crawler which crawls different web Universal Resource Locators (URLs) according to a particular schedule and stores the information in the reverse index database module 123. The process of crawling and storing data is shown in more detail in FIG. 2 herein. The reverse index database module 123 stores the web URLs according to certain keywords and arranges them alphabetically or via some other organizational scheme for easy retrieval. When a search request is received by the search server 107, the search engine 121 searches the already-built reverse index database 123 and produces certain relevant search result(s) if they are already available along with other search criteria. The cache database module 125 caches the data of recent search results (web URLs, links, pages, web contents, data, etc), such as search results resulting from alphanumeric key word searches, so that the search server does not need to fetch the data from the respective web servers. This caching is especially useful for data that is accessed repeatedly by one user or a plurality of users performing searches using the search server 107. The cached data remains in the cache until it is replaced by a data replacement algorithm. Sometimes the cached data remains only until a new search on the same keyword is performed and that search results in the storage of different web contents or search results. Active cache results from the cache database get shifted to the archive database of archive database module 127 once a new search gets performed. Only the most recent results are stored in the cache, and remaining older data blocks are shifted from the cache to the archive database as time passes or new search events occur. The search server maintains a reverse index database 123 containing the searched or visited web URLs, whereas the cache database 125 contains web data from the recently searched results, and whereas the archive database 127 contains web data associated with recent past search results.

When the search server 107 receives a search string or data associated therewith from the client device (e.g., device 109 containing a web browser 143), the search server first gets the list of URLs from the already-built reverse index database 123. If the contents of the reverse index database are not changed for that key word, then data from the cache database 125 is delivered to the client device 109 to satisfy the search request. If the search result is old but the web contents of the search result has not changed (as can be detected from digital signatures, cache tags, etc., for the data), the search result is retrieved from the archive database 127. But if the search results are very old, then the data is retrieved from the historical data repository 133 that stores old data in an organized manner that can be historically retrieved by search operations that indicate historical/past data on the web should be accessed. Often the data in the repository is time stamped or sequenced so that the relative age or precise age of the data resident in the repository 133 can be maintained and accessed during searches.

The search engine has a browser activity-based search module 129 and a favorite list-based search module 131 to refine the search results for the web browser 143 of the client device 109. The browser activity based module 129 keeps track of recent browser activity to facilitate faster and more relevant searches that pertain to the user's interest(s). The browser activity-based search module 129 keeps track of the region from where the search is being performed and produces relevant results accordingly. Also the module 129 keeps track of the already searched data from the cache of the web browser of client device 109 so that the search engine does not need to perform the search operation again if the client does not need the information updated at this time. The favorite list-based search module 131 keeps track of one or more user favorite lists. Favorite lists contain links, tags, or URLs of the web pages visited from the client device web browser that the user intends to visit frequently. During a search, the search server may search from the existing favorite list as per the user specification instead of searching the whole web. For example, a user may want to search content based on the keyword “computers” and enters the search string “computers” via the browser 143 of the client device 109. Also when the search engine receives instruction(s) to search from the existing favorite list it boils down the search to the domain defined by the user's favorite URL list(s).

The historical data repository 133 stores data in an organized manner. Repository 133 stores the data according to date and time and also according stores the data (e.g., in a relational database) to different versions as per one embodiment for later retrieval. The details of the data storage and retrieval are discussed in detail in FIG. 2 herein. With optional user preferences provided, the search engine searches the web pages for a given keyword or for correlations to a given keyword. When the user preference is for content from within a historical date, the data is retrieved from this historical data repository 133 by the search engine 107 and is delivered to the client device 109. Therefore, current web content may be derived for searching the current web server resources 111-115, whereas if historical data is sought (like news on the web from a week ago, or overwritten data from a long deleted web site of interest to the user), then the repository 133 is accessed. In some cases, a user may seek both current and historical data, whereby many sources, both current and historical repositories may be used to perform the search.

In one embodiment, a user that is trying to search for information about a particular search keyword may obtain search results by keying in the search keyword for use by the server using the web browser 143 of client device 109. The search server 107 then searches for the available URLs that correlated to the search keyword(s) and displays the correlating search result in the browser of the client device 109. According to this embodiment, the search server 107 provides data for various search preferences provided by the user. In some cases, the user preferences are to find historical or old data that was on the Internet a while ago but may have since been removed. Sometimes, the most important data is the data resident on the Internet on a past date. Therefore, a search with historical capability and infrastructure can provide data as it existed on the Internet in a past state or past date/time. For example, as per the present embodiment, a user can view web pages for a news website such as www.cnn.com as it existed at an older date (e.g., 1 Jun. 1999). The search server can also produce the webpage information for the news websites as it existed at that older time period.

In another embodiment, a mobile phone user may want to download a particular song. The user may want to download the song in a required format, such as MIDI for ring tone searches, by providing the keyword in the browsing interface of the mobile phone. The search server may search for the songs in the available/existing URLs and data set on the Internet via the search databases and storage areas of FIG. 1. The search may also search for data from the user specified browser favorites data 131 and time information/parameters. The search server displays a message on the client device browser screen about the availability of the song providing the link for download. The user can easily choose this link and get the required song onto his device, in some cases the song can be provided even it was deleted from the Internet days, months, or years ago. However, IT professionals and authorities will have access to the archived areas 123-127 and repository 133 whereby illegal, improper, or other socially unacceptable data can be purged from the historical memory of the Internet forever. This method can also filter out non-value-added content such as graphics, background data, logos, legal notices, etc.

FIG. 2 is a schematic block/step diagram 205 illustrating in detail the process of storing data in the historical data repository 217 during a web crawling operation performed by the search server 107 of FIG. 1. The web crawler 207 (resident within search server 107 of FIG. 1) crawls the web servers 211, 213 and 215 through the Internet 209 and stores data in a proper place for later retrieval. The web crawler has a URL server 219, a scheduler module 221, a URL content crawling module 223, a content change detection module 225, and the storage area/unit 227. The historical data repository 217 of FIG. 2 has an indexing module 229, a version manager 231, and a time-based retrieval module 233. The web crawler 207 crawls the web pages and stores data in the historical data repository 217 using its various components. The web servers 211, 213 and 215 have local storage 235, 237, and 239 of data for the web pages they are hosting and one or more servers 211-215 can also have an archive database module such as module 241 to store offline data that is not used often.

The URL server 219 within the web crawler 207 contains or can access a list of URLs to be crawled. This list is obtained by certain processes such as gathering Internet statistics based on region, favorite lists from the web browsers of many users around the globe, web pages with HTML web contents, and/or other methods. The scheduler module 221 does the scheduling of crawling of the URLs. The contents of the web pages keep on changing dynamically and hence the contents of web pages are crawled at regular intervals to maintain or capture historical states of these web pages. The scheduling is carried out by the web crawler 207 using certain Internet statistics accessible by the web crawler. The URL crawling module 223 actually goes into the websites accessed by the URL server 219, looks for the keywords based on certain algorithms, and stores the data in the storage area/unit 237 or in some other computer-readable memory over the Internet (like a RAID array storage unit, peripheral disk drive, or cloud computing storage area). The crawling module 223 not only crawls the current web page but also crawls down further URL links in accessed web pages and stores that sub-link data in the storage 237. The content change detection module 225 looks for various changes in the content of the web page. The changes can be found by active comparison of old content with the new content or via the monitoring of some metadata tag (ex. version number) or page date information. If changes are detected, then the module 225 allows the URL crawling module to crawl the URL to get the modified data and ensure that at least the changed data (and sometimes redundant unchanged data) is archived or stored in the storage 227 for later use. Furthermore, some content that can be detected by the crawler 207 may not be of future interest to the user, like advertisements or certain content like video files, whereby certain content can be skipped over by the crawler 207 when storing changed data or historical data from the internet.

The web crawler 207 often stores only recently-crawled “new” data in the storage 237. Older data beyond that stored as current data in the storage 237 is stored in historical data repository 217 according to one embodiment. When the web crawler crawls the web page(s) as described above, the URL web addresses and recently crawled data are stored in the storage 227. The historical data repository 217 then stores all the relevant historical data from the crawler 207 by utilizing its components. The repository 217 contains an indexing module 229, a version manager 231, and a time based retrieving module 233. Once the URL crawling module 223 crawls the web, the historical data repository 217 captures data using indexing module 229. The indexing module 229 has a reverse index database of the key words, the corresponding URL links, and the web data related thereto. The reverse index database in the module 229 is organized in an alphabetical order or some other method for easy retrieval. The version manager 231 facilitates storing of the web page contents according to different versions or time stamps obtained from the metadata or other information of the URLs crawled. All the relevant data within prior and current versions of a web page (including sub-content) resident at a particular URL is thus stored in the historical data repository 217 and the link is put in appropriate location of the reverse index database of module 229. The time-based retrieval module 233 stores the crawled web data according to the different date and time information and other information. For example, news web page content at 06:00 EST in the morning and 18:00 EST in the evening are different on a particular day and are stored for historical retrieval by the user with all its relevant contents over time per the embodiment of FIG. 2.

When a user requests a search operation using particular key word or words, if the URL link from the reverse index database is found to be recent and related to the search, the web data is retrieved from the cache database itself. But when the data is old yet related to the current search, if this data is not available in the more-current archive database of the search server, then the data is retrieved from the historical data repository. As per the indexing information (often data and time information), the historical data repository delivers the relevant web contents to the client device for the search being performed (this operation is not specifically shown in the figure).

In one example, a user may want to search for particular freeware software program that is an older version and therefore compatible with the older operating system the user is using. The user searches for this older version of software using the client device web browser by keying in the search word(s) for the software with the version number, date code, and/or other version identifying information. First, the search engine finds the URL from the reverse index database module and then the version manager locates the content of that particular version in the historical data repository (or storage 227 if recently accessed) and delivers that data/content to the client device when the search result is activated for download. In another example, a user may want to see the news articles for Time magazine's website as of Oct. 23, 2008. If this website for Time is present within the web crawler modules within crawler 207 and the site has been repository processed since Oct. 23, 2008, or longer, then the user can enter a search operation for certain Time content at a certain time into a browser and receive that information via the web browser.

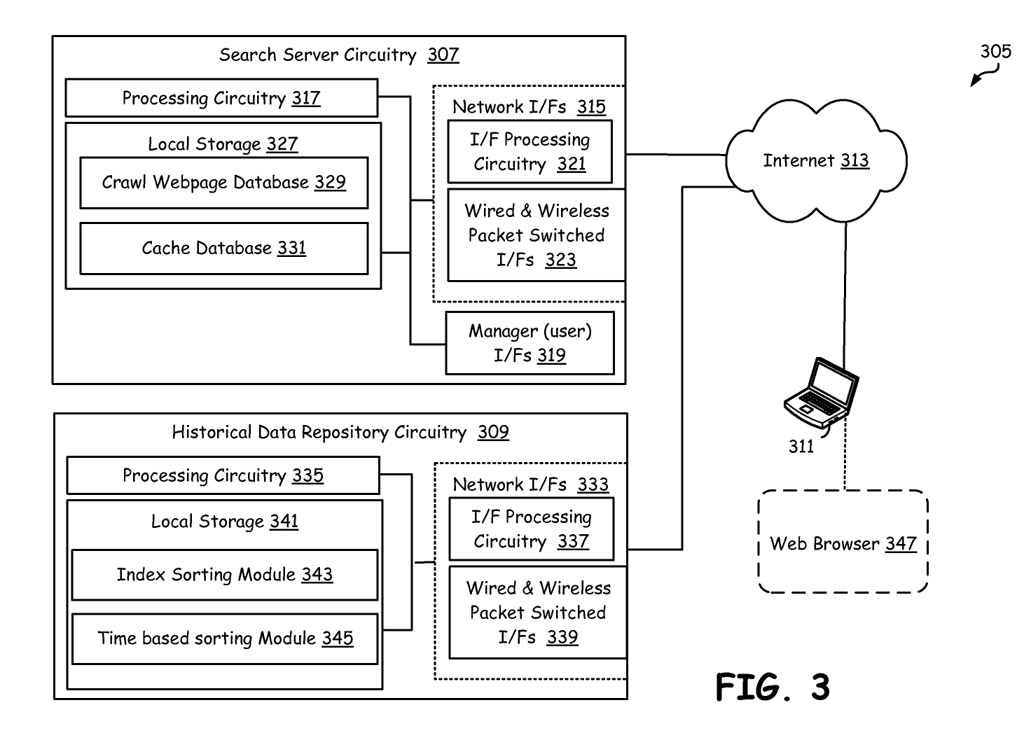

FIG. 3 is a schematic circuitry diagram 305 that illustrates various components of the search server of FIG. 1 and the historical data repository of FIG. 2 and their interaction with a client device that are shown in FIG. 1. The search server circuitry 307 is connected to the historical data repository circuitry 309 and the client device 311 through the Internet 313 or some other wireline, wireless, optical, and/or other network. The search server circuitry 307 generally includes processing circuitry 317, local storage 327, network interface 319, and user (admin) interface 319. These components are communicatively coupled to one another via one or more of a system bus, dedicated communication pathways, and/or other direct or indirect communication pathways. The network interfaces (I/Fs) 315 contain the interface processing circuitry 321 and wired/wireless packet switched interfaces 323. These functions can be hard wired with the processing circuitry 307 for faster search operation. The manager (admin) interface 319 facilitates the control of the search circuitry operations.

Local storage 327 may be random access memory (RAM), read-only memory (ROM), flash memory, a disk drive, an optical drive, and/or another type of memory that is operable to store computer instructions and/or data. The local storage 327 contains the crawl webpage database 329 and cache database 331. The crawl webpage database 329 stores the information of the URL addresses in a reverse index format or another functional format. The cache database 331 stores the data of certain recently-crawled web page contents hierarchically scanned and stored over time down to a desired level of sub-URL content.

Generally, the search engine utilizes different search algorithms to search efficiently for key word correlated content by crawling through the Internet. Each domain and sub domain URLs are searched for important keywords in the database during the crawling process. Once a new keyword is submitted by a user, the search server looks for the existing word in the database and retrieves the search result(s) if they are present in the database within local storage 327. If the word does not exist in storage 327, then the search engine crawls through the Internet and any associated searched web URLs are stored in the crawl webpage database 329.

The historical data repository circuitry 309 contains processing circuitry 335 and local storage 341. Circuitry 309 is connected to the search server circuitry 307 and the client device 311 (that has a web browser 347) through the Internet 313 and the network interfaces shown in FIG. 3. The network interfaces 333 contain wired and wireless packet switched interfaces 339. The network interfaces 333 may also contain built-in or an independent interface processing circuitry 337 to execute and handle communication specific tasks.

The processing circuitry 335 receives information from the Internet through the network interfaces 333 and processes it for use/storage in historical data repository circuitry 309. This circuitry 335 can be implemented through hardware for faster operation, or may be software or software in combination with custom hardware. The local storage 341 has an index-sorting module 343 and a time-based sorting module 345. The index-based sorting module 343 stores various web contents via a reverse index database or another suitable data structure for later retrieval. The time-based sorting module stores the crawled web data according to date and time or some other reasonable construct. The web page contents for different dates, times, and versions are stored in the local storage 341. This stored data is delivered to the web browser 347 of client device 311 through Internet 313 when the search result that is stored in the storage 341 is to be delivered upon user request.

In one example, a user wants to search for the on-line history of an individual that existed in a given duration of time on the Internet. The user searches for this info in the client device web browser by keying in the search string. The search server circuitry 307 first searches for the available URLs from the crawled URL database in storage 327. Since a request for old data is a request that is not available in the local storage of search engine, a request is made to the historical data repository circuitry for the search result information. The historical data repository 309 processes the request based on data and processes in the indexing module and the time-based sorting module, retrieves the correlating data, and sends the data to the client device web browser 347 through the search server 307.

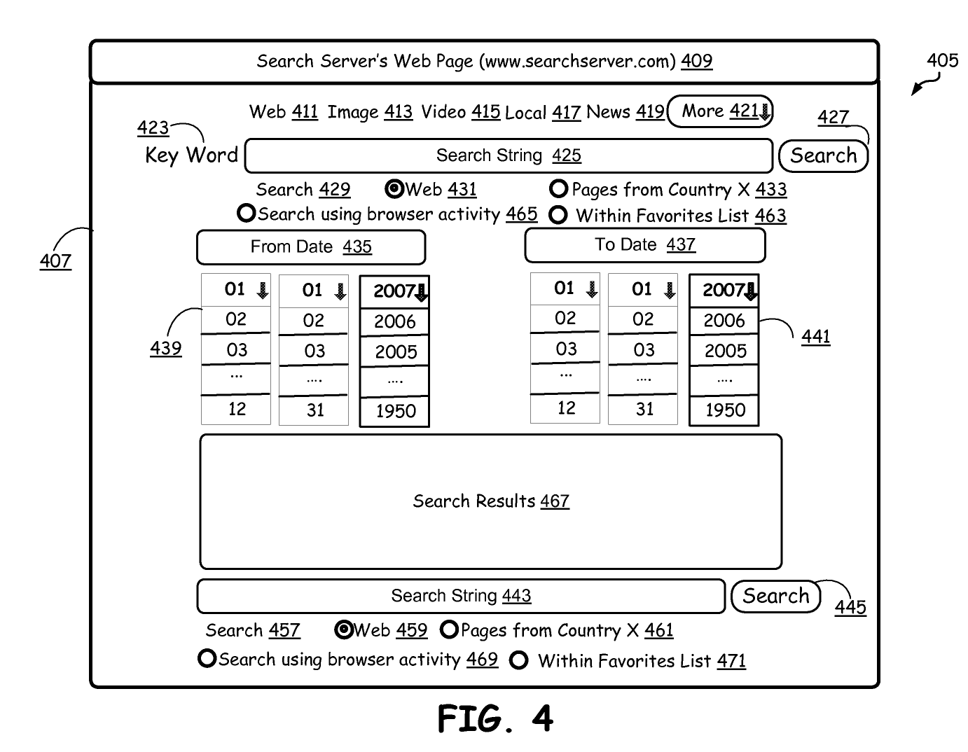

FIG. 4 is an exemplary schematic diagram 405 illustrating a screen shot of a search server web page that shows various options for searching web pages. The search server's title www.searchserver.com 409 is displayed on the top of the web browser 407 of the client device (FIG. 4 shows the client device display screen, and therefore the whole client is not shown in FIG. 4). The screen has links or selections for Web 411, Image 413, Video 415, Local 417, and News 419 as different types of searches that can be performed using keyword(s). A user inputs the keyword or phrases (via a search string 425 in FIG. 4) to enable the search in the keyword text box 423 and begins the search using the search button 427. Further search options are available by clicking the pull down menu More 421.

Below the search text box 423, search options 429 are provided with the ability to select or deselect them via different radio buttons or another selection mechanism. The search can be performed by clicking any of the radio buttons provided for web 431, pages from country X 433, search using browser activity 465, search within favorite list 463, etc. The option web 431 allows for a search from the entire web in contrast to the option pages from country X 433 that narrows down the search to a particular geographical region. The option search called search using browser activity 465 searches for the key words through the recently browsed websites that have URLs available in the web browser or searches the user's most frequently visited web sites.

Apart from these options there is an important option for performing a timed window search. A search can be provided with a time window, from date 435 and to date 437, including time limitations in some embodiments. The from date field 435 gives the lower bound of time lined data to be searched. It has a pull down option 439 for inserting date, month, and year, and can be input using a different interface. Similarly, the “to date” field 437 has also a pull down option 441 for inserting the upper date/time limit of time-based search. By default, the “from date” and the “to date” shows the current date obtained from the local client device operating system.

The boxed window 467 shows the space where search results are displayed when the search button 427 is activated with search criteria. Also at the bottom, a search text box similar to the top search box is also present. This has the same keyword search string 443 as search string 425 and other search options search button 445, search 457, web 459, pages from country X 461, search using browser activity 469 and search within favorite list 471 as the respective top ones. By clicking upon the search results from the search window, information from the respective URL links can be displayed.

In one example, a user keys in the search keyword “download free mp3 songs” in the text box 425, ticks from pages from country X 433, chooses the from date and to date between Jan. 1, 1980 and Jan. 1, 1985 and clicks the search button 427. The search server displays search results on the browser screen with the associated URLs, provided the data has been historically captured by the system. The user can download the corresponding mp3 song(s) that satisfy their search by clicking on the searched URL.

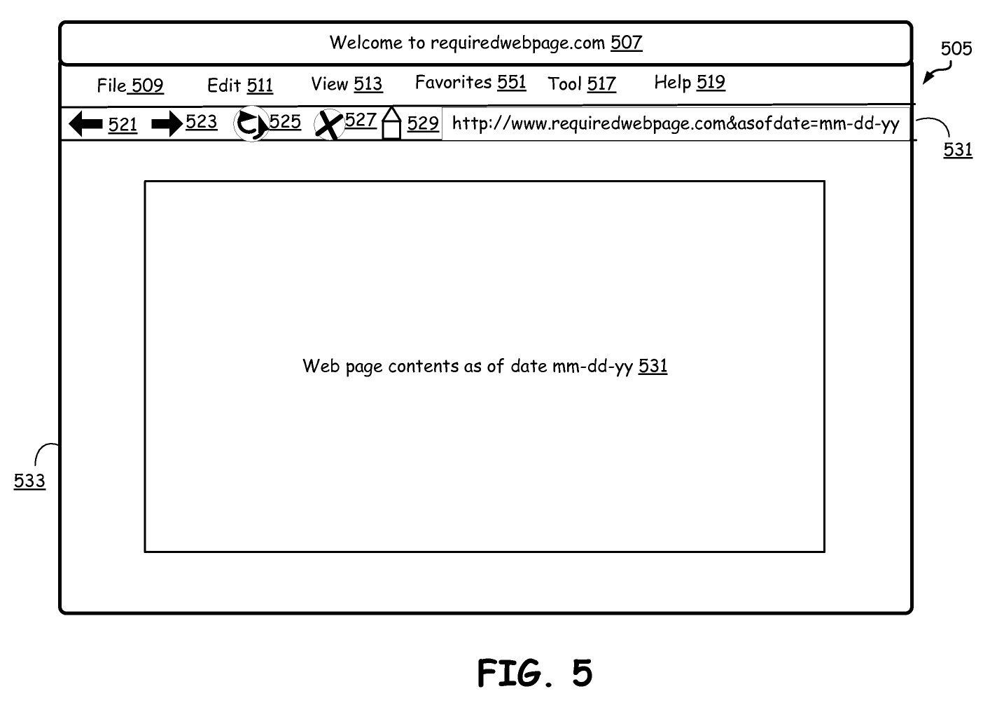

FIG. 5 is a schematic block/step diagram 505 illustrating a screen shot of the search web page after the search invoked by a client device of FIG. 1. A welcome message “Welcome to required webpage.com” 507 is displayed on top of the web browser 533 from the client device. The web browser has pull down menus File 509, edit 511, View 513, Favorites 515, Tools 517, and Help 519, and in other embodiments, different pull down menus are possible. These menus can have standard submenus such as open/close file, open/close locations for file menu; cut, copy, paste for Edit menu; view source, reload for View menu; add to favorites, organize for Favorite menu; web search, download, clear private data in Tools menu and help contents, about browser in Help menu. These standard submenus are not shown in FIG. 5. With these menus, a user on a client device can use the browser for searching. Apart from this textual view, there is a graphical view in icon form for some of these menus. Important interface buttons that are often graphically depicted are forward and backward arrows 521 and 523, reload symbol 525, stop symbol 527, and home icon 529. Block/step 531 is a text box where a user can enter the desired web address. As per the present invention, the user not only provides the web address in this text box but also can provide a search timeline for retrieving results within the specified time. In the text box 531, http://www.requiredwebpage.com&&asofdate=mm-dd-yy is shown. This data indicates that the www.requiredwebpage.com website as of date mm-dd-yy is displayed on the web browser. The ‘&&’ operation allows the browser to perform and-ing operation to narrow down result within the specified date as per present information. The web page contents are displayed in the text window 531.

In one example, a user that want to know the stock price of a particular company can key in the search word for the company and get the result of the webpage. The user can further key in the link which contains the stock price with date specifier && as of date mm-dd-yy so that he gets the stock value on that day from historically stored data as taught herein. The search results containing various links about the stock, such as its past performance selected using logical operators and the specified date(s), are provided to study market behavior around that time.

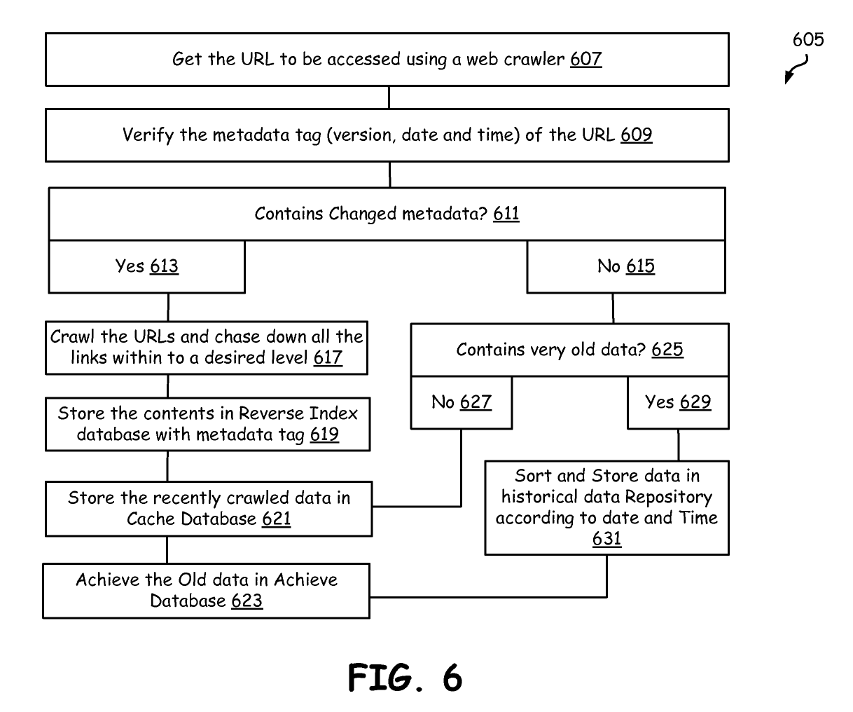

FIG. 6 is a schematic flow diagram 605 illustrating the storage of data in the historical data repository during a web crawling process performed by the search server illustrated in FIGS. 1-3. The flow begins at a block/step 607 where the search server gets the one or more URLs that are to be crawled by the web crawler. The URLs to be searched are refined by certain user preferences/selections such as search within favorites of browser, search within a given geographical region etc. At a next block/step 609, the metadata tag of the URL is verified for crawling to take place. The metadata tag could be the version number, date and time the webpage hosted.

At a next block/step 611, this metadata tag is examined for changes. If there is any change then the web page needs to be crawled since newer data has been uploaded in the web server. If the metadata change of block/step 611 is yes in a block 613, then the web URL is crawled at a block/step 617 along with the URLs down to a desired sub-URL level and the contents are stored in the local storage. At a block/step 619, these URL addresses are stored according to a reverse index database storage format where each keyword found in the URL will contain the URL address. At a next block/step 621, the recently crawled URL data is stored in the cache database. This is generally done so that the URL data need not be retrieved from the Internet, and instead can be retrieved from the cache database for some time. Recent old data is archived in the achieve database at a next block/step 623. This archived data is periodically shifted to the historical data repository at a block/step 631 as the cache space is overwritten or gets re-used. In some embodiments, duplicate copies are avoided by comparing what is stored in the repository to what is coming in as input date. The archived data from the search server is pushed periodically to clear off certain memory space. When pushed, this data is sorted and stored in the historical data repository that contains most of the Internet data.

When the metadata change of the block/step 611 is no in a block 615, then web data is examined if it contains old data at a next block/step 625. If the data is not very old as in the block/step 627, the flow shifts to block/step 621 where the contents of the web data are archived in a cache and periodically shifted over time to the historical data repository as previously discussed. If the URL contains very old data (a Yes in block 629), then the data is stored in the historical data repository at block/step 631. The data at the block/step 631 are stored based on date and time and/or also based on different versions.

In one example, the web crawler can update the information about the news web site www.cnn.com by first crawling the website. If the previous crawl was in the morning and current crawl is hours after that, then it is likely that the metadata tag of the news web content has changed. Hence, the crawler goes to the webpage, gathers the new data and stores the data in the local cache database initially, and after some time pushes it to archive database. After sometime, for example, after a week, this webpage data is pushed to the historical data repository with appropriate reverse index entry.

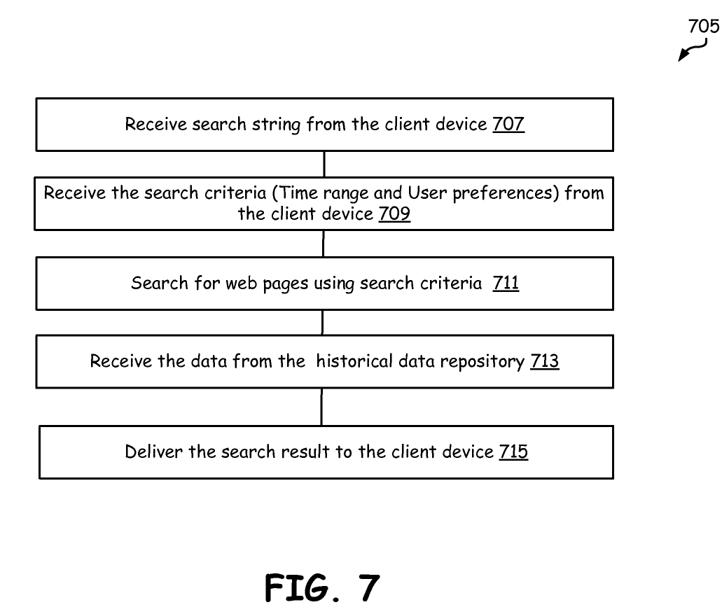

FIG. 7 is a schematic flow diagram 705 that illustrates a general search process that is performed by the search server located within the Internet infrastructure of FIG. 1. The flow begins at a block/step 707 where the search server receives the search string from the client device web browser. At a next block/step 709, the search server receives the search criteria to perform the search operation. The search criteria could be certain user preferences, such as a search within a specific period of time, a search within a specific geographical location, a search using browser activities, a search from the browser favorite lists, etc. Upon receiving search criteria, the search server searches for the appropriate results at a next block/step 711. At a next block/step 713, the search server retrieves the search data from the historical data repository. At a next block/step 715, these search results are delivered to the client device through the web browser.

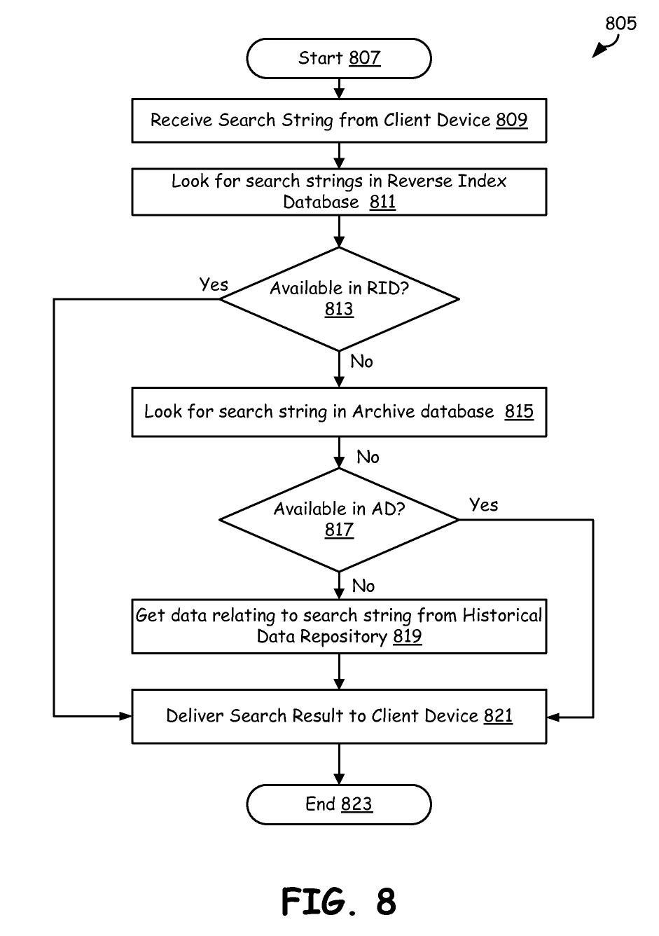

FIG. 8 is a schematic flow diagram 805 illustrating a search process for obtaining historical data via the search server of Internet infrastructure of FIG. 1. The method flow begins at a start block/step 807. At a next block/step 809, the search server receives the search string from the client device along with the search criteria. As described before, the search criteria are user defined/selected, such as search within the favorites, search within a region, search using browser activity. More specifically, the search criteria could be a timed window where the user looks for information in a specific past window of time/dates. Upon receiving the search string and criteria, at a next block/step 811, the search server looks for the string in the already present reverse index database that contains the web URLs. At a next block/step 813, a decision about the existence of the search string in reverse index database (RID) is taken. If the search string exists in this RID, then the method flow jumps to a block/step 821 where the search result from this RID is delivered to the client device. But if the search string does not exist in the RID, then the search string is examined in the archive database (AD) at a next block/step 815. The decision about the existence of search string in archive database is taken at a next block/step 817. If the search string exists in AD, then the method flow jumps to the block/step 821 where the search result from AD is delivered to the client device of FIG. 1. If the search string does not exist in AD, then the search string is examined in the historical data repository at a next block/step 819. In the historical data repository, the search string is looked for in the indexing module. The appropriate data for the search string is retrieved from the historical data repository with the user specified search criteria, including the timed window search information if provided. At a next block/step 821, the searched data is delivered to the client device. The method flow ends at an end block/step 823.

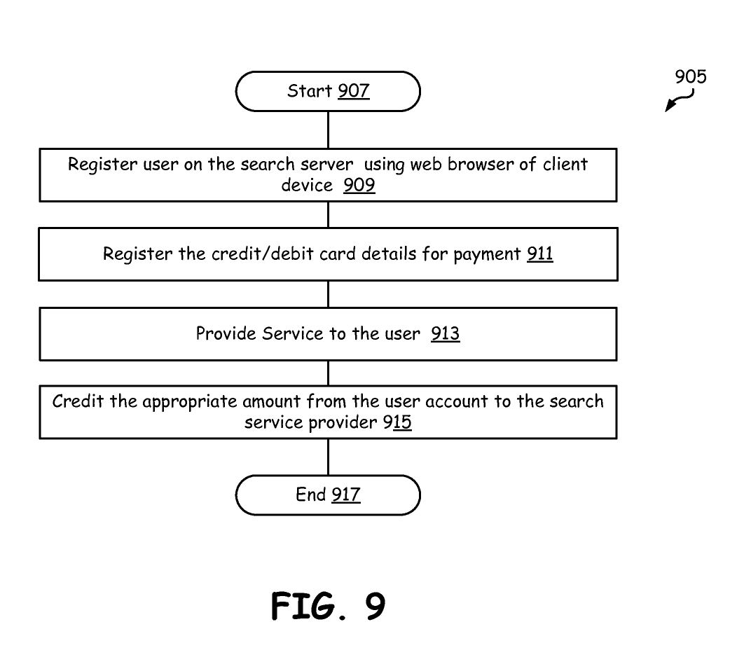

FIG. 9 is a flow diagram 905 illustrating a payment procedure used to allow the user to obtain historical data in accordance with the embodiments taught herein. The method flow begins at a start block/step 907. At a next block/step 909, the user is registered on the search server to collect certain details of the user through the client device web browser. The registration process includes the name, address, and certain preferences for search and may provide a user login and unique password for the user. At a next block/step 911, the user credit card details for the user are provided/registered, such as card type, card number, and date of expiry for payment purposes. At a next block, the search server provides the search service as explained in FIGS. 1-8. Since the data is retrieved from a historical repository, the server charges the user for providing services from the repository. The appropriate amount per transaction, per access, per data provided, etc., is credited from the user account to search service provider account once the search service is provided at a block/step 915. The appropriate amount is decided by the search server, and the importance and availability of the data retrieved can be taken into account when setting billing rates. The method flow ends at an end block/step 917.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip,” as used herein, refers to an integrated circuit. Circuits and circuitry may comprise general or specific purpose hardware, or may comprise such hardware and associated software such as firmware or object code.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module may or may not modify the information of a signal and may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description, and can be apportioned and ordered in different ways in other embodiments within the scope of the teachings herein. Alternate boundaries and sequences can be defined so long as certain specified functions and relationships are appropriately performed/present. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block/step boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof. Although the Internet is taught herein, the Internet may be configured in one of many different manners, may contain many different types of equipment in different configurations, and may replaced or augmented with any network or communication protocol of any kind.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. An Internet system that supports a search service, the Internet system comprising:
a search server that is adapted to receive search criteria from a client device remote from the search server;
a historical data repository coupled to the search server, wherein the historical data repository contains historical data collected from over the Internet, and wherein the search server stores data retrieved from over the Internet and eventually stores the data as historical data within the historical data repository when the data is no longer preserved in the search server; and
wherein the search server receives the search criteria to search for older historical data that was in existence on the Internet at a previous time, wherein the search server obtains search results to satisfy the search criteria by searching the historical data stored in the historical data repository.

2. The Internet system of claim 1 wherein the historical data placed within the historical data repository is date tagged so that the historical data is associated with a date representative of when the historical data was available on the Internet.

3. The Internet system of claim 2 wherein the historical data placed within the historical data repository is time tagged so that the historical data is associated with a time representative of when the historical data was available on the Internet.

4. The Internet system of claim 1 wherein the historical data placed within the historical data repository is time tagged so that the historical data is associated with a time representative of when the historical data was available on the Internet.

5. The Internet system of claim 1 wherein the search server contains a cache memory that temporarily stores the data retrieved from over the Internet and eventually transfers the data to an archival database module that manages historical content within the search server and eventually moves historical content on the search server to the historical data repository to support historical searching.

6. The Internet system of claim 1 wherein the historical data repository comprises:
central processing circuitry;
communication circuitry coupled to the central processing circuitry for communicating data in to and out from the historical data repository; and
local storage coupled to the central processing circuitry that contains an index storage module for storing historical data according to indices and a time based sorting module for storing historical data according to date and time.

7. The Internet system of claim 1 wherein certain data is removed from the historical data before it is placed for long-term storage within the historical data repository.

8. The Internet system of claim 7 wherein the certain data that is removed from the historical data comprises one type of data selected from the group consisting of: advertisements, illegal content, and non-value added content.

9. The Internet system of claim 1 wherein the search server can search historical data along with browser activity based data associated with a user and favorites data associated with the user.

10. The Internet system of claim 1 wherein the search server is coupled to a web crawler that periodically crawls the internet to retrieve Internet content from predetermined Internet locations, and wherein the search server time/date stamps that Internet content and places that Internet content in the historical data repository for later time/date historical searching by a user.

11. The Internet system of claim 10 wherein the web crawler comprises:
a URL server for storing URLs that are to be periodically crawled;
a scheduler module for scheduling and starting web crawling operations using the web crawler;
a URL crawling module for crawling the predetermined Internet locations for the Internet content; and
a content change detection module for determining if the Internet content is different from the content stored previously in the historical data repository and storing new Internet data in the historical data repository as a part of the historical data.

12. The Internet system of claim 1 wherein the historical data contains sub-links that connect to other data and wherein the system also historically archives the other data within the sub-links for historical preservation and historical searching by a user.

13. The Internet system of claim 1 wherein a content change detection module determines if data retrieved from over the Internet is different from the content stored previously in the historical data repository and stores only those portions that are different from historical data already stored within the historical data repository as a part of the historical data.

14. A method of searching for at least one web page requested by a client device, the method comprising:
receiving a search string from the client device;
receiving the user provided search criteria from the client device, wherein the search criteria indicates a desire to find historical content that was previously present over the Internet;
gathering search results containing historical data from previous states of the Internet;
ordering search results by determining which search results are most likely of interest to the user; and
sending the search results to the client device.

15. The method of claim 14, wherein the user provided search criteria is set to search web pages within a specific geographical region.

16. The method of claim 14, wherein the user provided search criteria is set to search web pages using browser activities of the client device web browser.

17. The method of claim 14, wherein the user provided search criteria is set to search web pages within favorite website information.

18. A method of operating a search server that is useful for searching historically archived Internet content, including steps for paying for the search service, the method comprising:
registering a user on the search server;
performing a search for the user using the search server, the search capable of searching not only current Internet data, but also capable of searching archived historical Internet data stored in a historical data repository coupled to the search server;
determining the amount to be charged to the user based on the search services rendered; and
charging the user for the search services provided.

19. The method of claim 18 wherein the amount due is automatically processed for payment by credit card information of the user that is securely accessible by the search server.

20. A network browser in a computer for browsing websites, the network browser comprising:
a search criteria window that prompts a user to enter search terms and timeline information;
a first module that enables a search of the Internet to determine search results that existed within a time frame delineated by the timeline information, and wherein the search results correlate to the search terms; and
a second module that receives the search results from over the Internet.
